(19) United States
(12) Patent Application Publication
(10) Pub. No.: US 2011/0246628 A1
(43) Pub. Date: Oct. 6, 2011

(54) INFORMATION COMMUNICATION SYSTEM, INFORMATION PROCESSING APPARATUS, INFORMATION COMMUNICATION METHOD AND COMPUTER READABLE STORAGE MEDIUM

(75) Inventor: JUN SUZUKI, Kasugai-shi (JP)

(73) Assignee: BROTHER KOGYO KABUSHIKI KAISHA, Aichi-ken (JP)

(21) Appl. No.: 13/035,207

(22) Filed: Feb. 25, 2011

(30) Foreign Application Priority Data
Mar. 31, 2010 (JP) 2010-084003

(51) Int. Cl. G06F 15/177

(52) U.S. Cl. 709/220

(57) ABSTRACT

An information communication system comprising an information processing apparatus and a plurality of node devices in which contents delivered within the information communication system are stored in a distributed manner by an overlay network constituted by the plurality of node devices, the information processing apparatus comprising: an acquisition unit that configured to acquire a plurality of contents associated by a predetermined structure; a generation unit that configured to generate first information comprising location information indicating locations of the plurality of contents in the predetermined structure and the identification information for identifying the plurality of contents associated by the predetermined structure, and the location information and the identification information are corresponding to each other; a second assignment unit that configured to assign identification information for identifying the first information in the overlay network to the first information.

### BACKGROUND OF THE INVENTION

1. Field of the Invention

The present invention relates to the technical field of an information communication system including a plurality of node devices and an information processing apparatus that can communicate with one another. The “node device” is hereinafter referred to as a “node” as appropriate.

2. Description of the Related Art

In recent years, a content delivery system that delivers contents such as movies and moving images via a network such as the Internet has been developed. The content delivery system delivers contents to nodes participating in the network. Since further services improvements are attempted in such a content delivery system, such as improvement in image quality or sound quality of the contents and delivery of data other than movies, the amount of data for the contents tends to increase. When data delivery is requested in a client-server scheme, since all the nodes access a specific server, the burdens are concentrated on the server.

Thus, a peer-to-peer (P2P) type network system has been developed in recent years. In the P2P-type network system, contents are stored in a distributed manner in each of nodes within the network system. Each node transmits and receives contents to and from each other while sharing the contents among the nodes. The location of the contents stored in a distributed manner in the P2P-type network system is efficiently searchable by a query using a distributed hash table. The query includes as a key a content ID specific to each content. The distributed hash table is hereinafter referred to as a DHT (Distributed Hash Table). The P2P-type network system is hereinafter simply referred to as a P2P system.

A content ID is assigned to each content in order to enter contents into the P2P system for delivery. The content ID is information by which a desired content can be uniquely identified even from among a large amount of contents. This is because, if only the name of the content is used, there is a possibility that another content may be entered with the same content name. Therefore, in the P2P system, assignable content IDs have to be prepared in advance so that a large amount of contents can be identified.

### SUMMARY OF THE INVENTION

There is a request demanding that a composite content be generated using a predetermined plurality of contents from among the contents delivered through the P2P system. In this case, a plurality of desired content IDs are selected from among assigned content IDs. Then, a composite content is generated with the contents corresponding to the selected content IDs. In this manner, a composite content is generated and delivered. This request is received from distributors or creators of composite contents. In such a composite content, the playback sequence and the playback condition of each content are determined by the distributors or creators of the composite content.

However, in the P2P system, there is a problem of an increase in the burden on the distributor or the like, in delivering a composite content. More specifically, in order to deliver a composite content, first, all of a plurality of contents constituting the composite content has to be entered once into the P2P system. Thereafter, each content ID has to be assigned. Furthermore, processing is required for each content, such as, for example, populating a Web page manually with the assigned content IDs.

Thus, the present invention is accomplished in light of the above problem. An object of the present invention according to an embodiment is to provide an information communication system, an information processing apparatus, a recording medium having a program recorded therein, and an information communication method, capable of delivering each content with simplified processing while a predetermined structure as a composite content is maintained.

In order to solve the above described problem, there is provided an information communication system comprising an information processing apparatus and a plurality of node devices in which contents delivered within the information communication system are stored in a distributed manner by an overlay network constituted by the plurality of node devices, the information processing apparatus comprising, an acquisition unit that configured to acquire a plurality of contents associated by a predetermined structure, a first assignment unit that configured to assign identification information for identifying the contents in the overlay network to the plurality of contents acquired by the acquisition unit, a generation unit that configured to generate first information comprising location information indicating locations of the plurality of contents in the predetermined structure and the identification information for identifying the plurality of contents associated by the predetermined structure, and the location information and the identification information are corresponding to each other, a second assignment unit that configured to assign identification information for identifying the first information in the overlay network to the first information, and, an entry unit that configured to enter into the overlay network the plurality of contents acquired by the acquisition unit and the first information.

In order to solve the above described problem, there is provided an information processing apparatus of an information communication system comprising the information processing apparatus and a plurality of node devices in which contents delivered within the information communication system are stored in a distributed manner by an overlay network constituted by the plurality of node devices, the information processing apparatus comprising an acquisition unit that configured to acquire a plurality of contents associated by a predetermined structure, a first assignment unit that configured to assign identification information for identifying the contents in the overlay network to the plurality of contents acquired by the acquisition unit, a generation unit that configured to generate first information comprising location information indicating locations of the plurality of contents in the predetermined structure and the identification information for identifying the plurality of contents associated by the predetermined structure, and the location information and the identification information are corresponding to each other, a second assignment unit that configured to assign identification information for identifying the first information in the overlay network to the first information, and an entry unit that configured to enter into the overlay network the plurality of contents acquired by the acquisition unit and the first information.

In order to solve the above described problem, there is provided a non-transitory computer readable storage medium storing a program that causes a computer included in an information processing apparatus of an information communication system comprising the information processing apparatus and a plurality of node devices in which contents delivered within the information communication system are stored in a distributed manner by an overlay network constituted by the plurality of node devices, to execute the steps of, acquiring a plurality of contents associated by a predetermined structure, assigning identification information for identifying the contents in the overlay network to the plurality of contents acquired, generating first information comprising location information indicating locations of the plurality of contents in the predetermined structure and the identification information for identifying the plurality of contents associated by the predetermined structure, and the location information and the identification information are corresponding to each other, assigning identification information for identifying the first information in the overlay network to the first information generated, and entering into the overlay network the plurality of contents acquired and the first information generated. In order to solve the above described problem, there is provided an information communication method performed in an information communication system comprising an information processing apparatus and a plurality of node devices in which contents delivered within the information communication system are stored in a distributed manner by an overlay network constituted by the plurality of node devices, the information communication method comprising steps, acquiring a plurality of contents associated by a predetermined structure, assigning identification information for identifying the contents in the overlay network to the plurality of contents acquired in the acquisition step, generating first information comprising location information indicating locations of the plurality of contents in the predetermined structure and the identification information for identifying the plurality of contents associated by the predetermined structure, and the location information and the identification information are corresponding to each other, assigning identification information for identifying the first information in the overlay network to the first information generated in the generation step, and entering into the overlay network the plurality of contents acquired in the acquisition step and the first information generated in the generation step.

### BRIEF DESCRIPTION OF THE DRAWINGS

FIG. 1 is a diagram showing an example of a connection mode of each node in a delivery system of a first embodiment;

FIGS. 2A to 2C are diagrams showing an example of a content configuration and the like of the first embodiment, FIG. 2A being a diagram showing an example of the structure of a composite content, FIG. 2B being a diagram showing an example of the relationship of the composite content and an index content, FIG. 2C being a diagram showing another example of the structure of the composite content;

FIGS. 3A and 3B are schematic block diagrams showing the configuration of an entry server and the like of the first embodiment, FIG. 3A being a schematic block diagram showing the configuration of the entry server, FIG. 3B being a schematic block diagram showing the configuration of a node;

FIGS. 4A to 4C are flowcharts showing a content delivery operation of the first embodiment, FIG. 4A being a flowchart showing the operation of an instruction server, FIG. 4B being a flowchart showing the operation of the entry server, FIG. 4C being a flowchart showing the operation of the node;

FIGS. 5A to 5D are diagrams showing an example of a composite content delivery operation and the like of the first embodiment; FIG. 5A being a diagram showing an example of the description of a Web page used for the composite content delivery operation of the first embodiment, FIG. 5B being a diagram showing an example of a content acquisition operation in the content delivery operation of the first embodiment, FIG. 5C being a diagram showing an example of the description of a Web page used for a content delivery operation of a second embodiment, FIG. 5D being a diagram showing an example of an index file of the second embodiment; and

FIGS. 6A to 6C are flowcharts showing the content delivery operation of the second embodiment, FIG. 6A being a flowchart showing the operation of an instruction server, FIG. 6B being a flowchart showing the operation of an entry server, FIG. 6C being a flowchart showing the operation of a node.

### DETAILED DESCRIPTION OF THE PREFERRED EMBODIMENTS

Next, an example of embodiments of the present invention will be described with reference to the drawings. In each embodiment described below, a case where the present invention is applied to a delivery system using a P2P system is described. In the delivery system of each embodiment, a composite content is delivered to each node.

### (1) First Embodiment

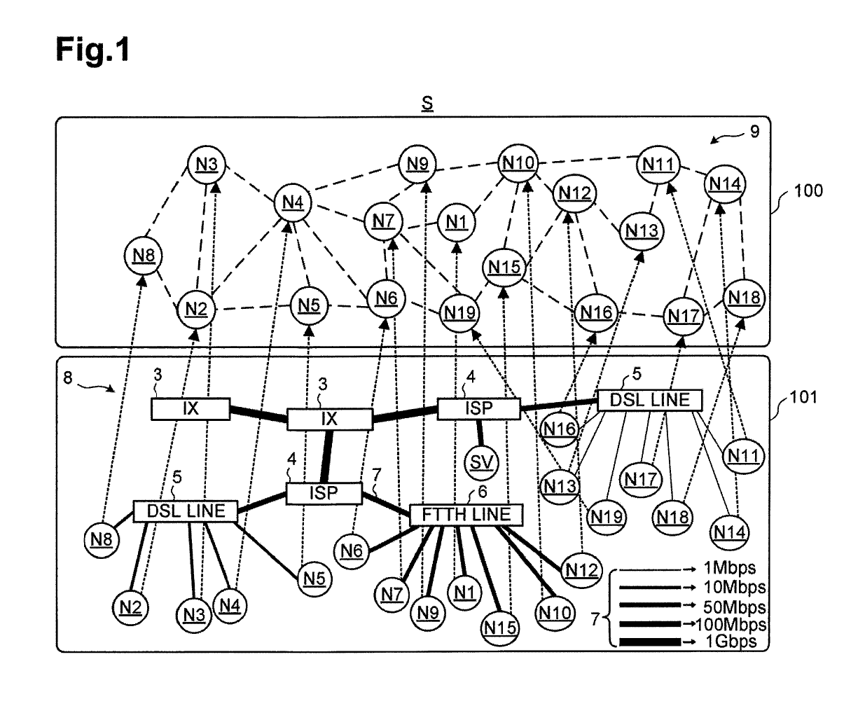

A first embodiment of the present invention will be described with reference to FIG. 1 to FIGS. 5A to 5D.

### (A) Overall Configuration and Operation of Delivery System

First, the overall configuration and operation outline of a delivery system of a first embodiment will be described with reference to FIG. 1. FIG. 1 includes a concrete configuration diagram 101 and a conceptual configuration diagram 100 of a contents dispersive-saving system S. As shown in the concrete configuration diagram 101 of FIG. 1, a network 8 such as the Internet is constituted by an IX (Internet exchange) 3, an ISP (Internet Service Provider) device 4, a DSL (Digital Subscriber Line) provider device 5, an FTTH (Fiber To The Home) provider device 6, a communication line 7 and the like. The network 8 is a real-world physical communication network. More specifically, the communication line 7 is constituted by a telephone line, an optical cable and the like. Although not shown, routers for transferring packetized data are inserted in the network 8 of the example shown in FIG. 1 as necessary.

A plurality of nodes Nn (n=1, 2, 3, . . . ) are connected to the network 8 of the embodiment. The node Nn is hereinafter referred to as a “node”. Each node is assigned a unique manufacturing number and an IP (Internet Protocol) address. This node corresponds to an example of a “node device”.

The delivery system S of the embodiment is the P2P system as described above. The delivery system S includes a plurality of nodes and an entry server SV. The entry server SV is accessible to each node through the network 8. The entry server SV corresponds to an example of an “information processing apparatus”. The entry server SV is a server for entering contents into the delivery system S. In other words, the entry server SV is a server for entering contents into an overlay network 9 described later. Here, entering contents means that a new content is stored in one or more nodes participating in the overlay network 9. A node device constituting the overlay network may have the function of the entry server SV.

The network shown in the conceptual configuration diagram 100 of FIG. 1 is the overlay network 9 configuring a virtual link made by a use of the existing network 8. The overlay network 9 is a logical network. The overlay network 9 is achieved by a specific algorithm, for example, an algorithm using the DHT described above. Each node participating in the overlay network 9 is assigned a node ID. The node ID is specific identification data having a predetermined number of digits. The node ID is identification information for identifying the node device participating in the overlay network 9. In addition, each node has a routing table using the DHT stored therein. Such a routing table using the DHT is known in US Patent Application Publication No. 2007/283043A1, which is incorporated herein by reference and hence the detailed description thereof is omitted.

In the delivery system S, contents are stored in the plurality of nodes in a distributed manner in a predetermined file format. Examples of contents include moving image data, music data, character data and image data. Each content is assigned information such as a content name and a content ID. The content ID assigned to the content is specific identification data to each content. The content ID is identification information for identifying the content. The content ID also includes data of search information for searching for a location of the node in the delivery system S. The content ID is used when searching for location information of the node in which the content corresponding to the content ID is stored.

On the other hand, in the delivery system S, index information is used. The index information includes a set of information indicating the location of a content, the content ID of the content and the like. The information indicating the location of the content is node information of the node that is a holding node for the content, for example. The node information includes a node ID, an IP address, a port number and the like of the node. The index information is stored or managed in an index cache of the node and the like managing the location of the content. The node managing the location of the content is hereinafter referred to as a “root node”. For example, a node having the closest node ID to the content ID is determined as the root node. For example, whether or not the node ID is closest to the content ID is determined based on whether or not there are a larger number of matches in connection with high order digits.

In the delivery system S, a user of a predetermined node participating in the delivery system S desires to acquire a content. The node operated by the user who desires to acquire the content is hereinafter referred to as a “user node”. When the user desires to acquire the content, the user node of the desiring user refers to a content delivery page or catalog information acquired from a predetermined server to acquire the content ID. The content ID acquired at that time is the content ID of the content that is requested to be acquired by the user. The content delivery page is a Web page in which the content ID is described. An example of a server that delivers the content delivery page is an instruction server. The instruction server is operated by an entry instructor who executes entry instructions for a content. On the other hand, the catalog information is information in which the record of a content is described. A content ID, a content name, a keyword and the like of the content are described in the record of the content. When a content is entered into the delivery system S, the record of the content is generated. Then, the catalog information including the generated record is delivered, for example, from a content management server to each node.

Upon acquisition of the content ID of the desired content, the user node acquires the content from the overlay network 9 based on the acquired content ID. More specifically, the user node generates a content location query message. The content location query message includes a content ID of the content to be acquired and an IP address of the user node itself. The content location query message is transmitted to another node according to the routing table using the DHT. The routing table using the DHT is stored in the user node. That is to say, the user node transmits the content location query message to the root node. As a result, the content location query message finally arrives at the root node by routing using the DHT that uses the content ID as a key. Such DHT routing is also known in US Patent Application Publication No. 2007/0283043 A1, which is incorporated herein by reference and hence the detailed description thereof is omitted.

Upon reception of the content location query message, the root node acquires the index information from the index cache. At that time, the acquired index information is index information corresponding to the content ID contained in the content location query message. Then, the root node sends back the index information to the user node that is a transmission source of the content location query message. Upon acquisition of the index information, the user node accesses the holding node based on the IP address and the like of the holding node contained in the acquired index information. As a result, the user node can acquire the content from the holding node accessed by the user node.

The root node may transmit a content transmission request message to the holding node. The content transmission request message is a message that instructs the holding node to transmit a content to the user node. In this case, the holding node is a holding node indicated by the IP address and the like contained in the index information. At that time, based on the content transmission request message, the holding node accesses the user node to transmit the content.

A content that the user node can use alone as described above is referred to as a general content. In addition, the user node can use a composite content. The composite content includes a plurality of contents associated by a predetermined structure. Each content constituting the composite content is stored in a distributed manner in the delivery system S, similarly to the general content. The user node acquires each content constituting the composite content from the holding node for each content through the overlay network 9. Through all the contents acquired by the method described above, the composite content is gathered in the user node and becomes playable.

The content ID of each content constituting the composite content is described in an index file of the composite content. The index file of the composite content is a file for searching for each content constituting the composite content. The index file corresponds to an example of “first information”. Location information is described in the index file of the composite content. The location information indicates a location of each content in a predetermined structure of the composite content. The location information of each content is associated with a content ID and described in the index file. In addition, a content ID is assigned to the index file of the composite content. The content ID assigned to the composite content is a specific content ID for identifying the index file of the composite content. Then, the index file of the composite content is entered into the delivery system S as one content. Thus, based on the content ID of the entered index file, each node can acquire the index file from the overlay network 9. “Acquiring from the overlay network 9” means downloading from the holding node via the overlay network 9.

### (B) Structure of Composite Content

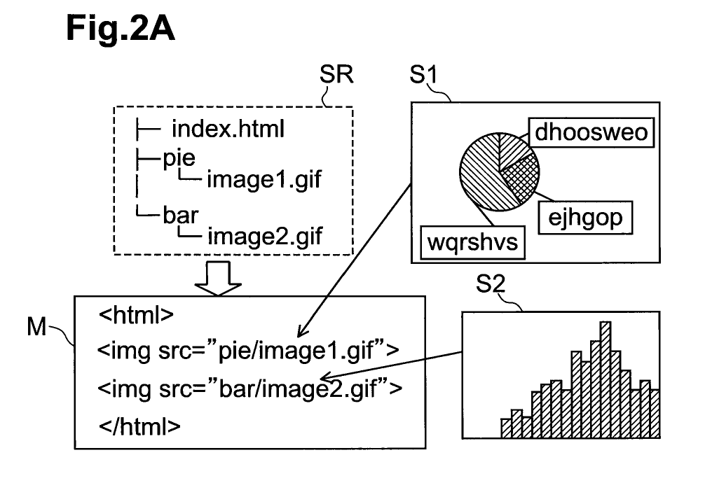

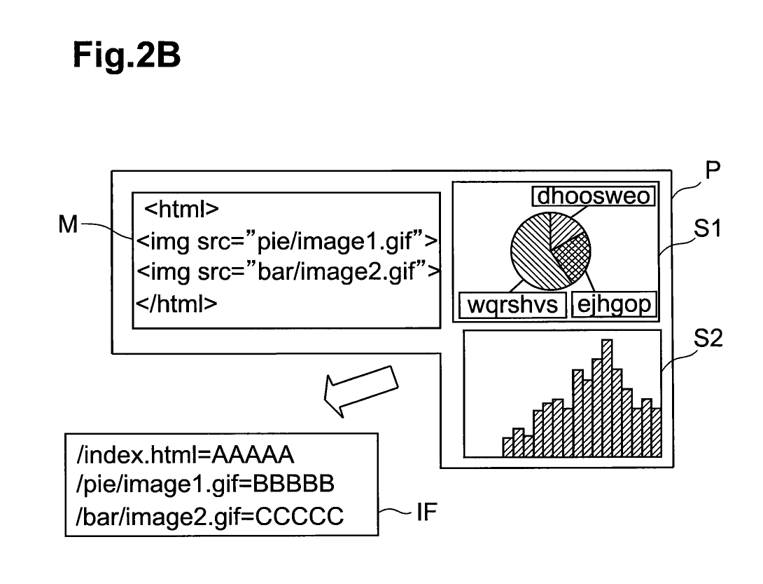

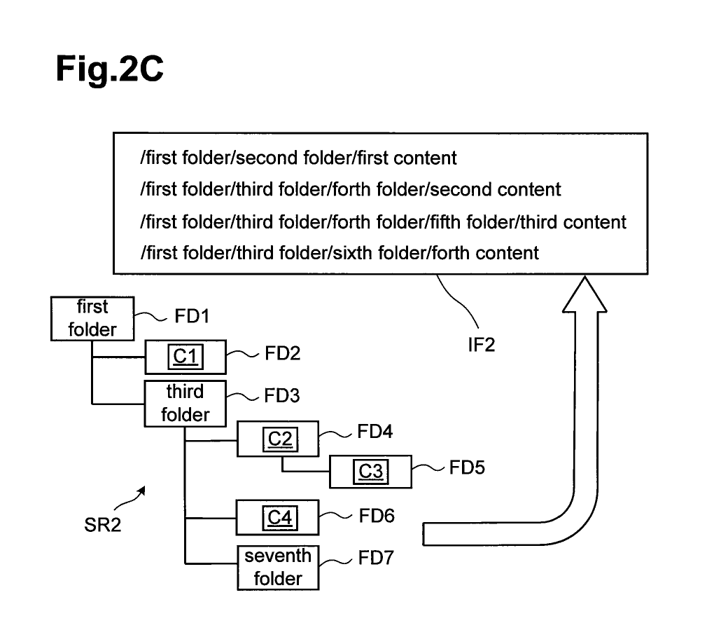

Next, the structure of the composite content of the first embodiment will be described specifically with reference to FIG. 2A to 2C. As shown in FIG. 2A, the predetermined structure of the composite content of the first embodiment is, for example, a hierarchical structure SR illustrated in FIG. 2A. Here, a description will be provided in connection with a Web page as an example of the composite content. The Web page is constituted by an HTML document file, an image file and the like. Generally, a predetermined hierarchical structure is used to display a Web page. For example, each content to be displayed is indicated by a relative path in a Web server that provides the Web page. The hierarchical structure SR is information for the user node to display a Web page as a composite content. The hierarchical structure SR shown in FIG. 2A is a file structure in which a content to be displayed as a Web page is managed, for example.

The hierarchical structure SR includes a main content M and sub contents S1 and S2 as shown in FIG. 2A. The main content M is a content named “index.html” shown in FIG. 2A. The sub contents S1 and S2 are two contents named “image1.gif” and “image2.gif”, respectively, shown in FIG. 2A. The hierarchical structure SR hierarchically includes the main content M and the sub contents S1 and S2. The main content M is a content for the user node to acquire each of the sub contents S1 and S2. For example, the main content M includes a relative path of each of the sub contents S1 and S2.

For example, the user of the user node first displays the main content M on a predetermined display unit. Then, the user of the user node uses the relative path contained in the main content M to specify the sub content S1 or the sub content S2. Thus, the user of the user node can acquire the sub content S1 or the sub content S2.

A description will be provided using concrete examples below. First, based on the main content M, the Web page corresponding to the main content M is displayed. Therefore, as shown by solid arrows in FIG. 2A, the name of each sub content S1, S2 is described in the main content M. As shown by solid arrows in FIG. 2A, the location information indicating a location of each sub content S1, S2 in the hierarchical structure SR is also described. For example, when the relative path <img src=“pie/image1.gif”> of the main content shown in FIG. 2A is specified, the sub content Si shown in FIG. 2A is acquired. The acquired sub content S1 is displayed on the display unit. Meanwhile, when the relative path <img src=“pie/image2.gif”> of the main content shown in FIG. 2A is specified, the sub content S2 shown in FIG. 2A is acquired. The acquired sub content S2 is displayed on the display unit. A detailed method of acquiring the sub content S1 or the sub content S2 will be described later.

FIG. 2B illustrates a compressed file P. The compressed file P is one compressed file that gathers the main content M and the sub contents S1 and S2 constituting the composite content illustrated in FIG. 2A. Here, the compressed file P of FIG. 2B is an image illustrating that the main content M and the sub contents S1 and S2 are gathered into one compressed file. “Gathering into one compressed file P” means that the main content M and the sub contents S1 and S2 can be processed as one file while the structure as a composite content is maintained. In the compressed file P after compression, information indicating an original structure is described as, for example, header information thereof.

Further, as shown in FIG. 2B, the location information indicating the hierarchical structure SR shown in FIG. 2A is described along with name information in an index file IF. The name information indicates each name of the main content M and the sub contents S1 and S2.

The index file IF is a file for acquiring a Web page as a composite content. That is to say, regarding the main content M, the location information “/” in the hierarchical structure SR and the name information as “/index.html” in the index file IF illustrated in FIG. 2B are described. In the main content M “/index.html”, “/” represents location information indicating that the main content M is at the highest position in the hierarchical structure SR. In addition, “index.html” is name information indicating the name of the main content M.

In addition, regarding the sub content S1, the location information in the hierarchical structure SR and the name information are described as “/pie/image1.gif”. In the sub content S1 “/pie/image1.gif”, “/pie/” is location information indicating that the sub content S1 is under the main content M in the hierarchical structure SR. More specifically, “/pie/” indicates that the sub content S1 is located at “pie” under the main content M. In addition, “image1.gif” is the name information. The location information and name information of the sub content S1 is information for the user node to acquire the content ID. More specifically, the content ID to be acquired is a content ID for identifying the sub content S1.

In addition, regarding the sub content S2, the location information in the hierarchical structure SR and the name information are described as “/bar/image2.gif”. In the sub content S2 “/bar/image2.gif”, “/bar/” is location information indicating that the sub content S2 is under the main content M in the hierarchical structure SR. More specifically, “/bar/” indicates that the sub content S2 is located at “bar” under the main content M. In addition, “image2.gif” is the name information. The location information and name information of the sub content S2 is information for the user node to acquire the content ID. More specifically, the content ID to be acquired is a content ID for identifying the sub content S2.

In addition, the location information also represents that the sub contents S1 and S2 are contents to be acquired by using the main content M. A content ID is also described in the index file IF in addition to the location information and the name information. More specifically, as shown in FIG. 2B, for the main content M, the content ID “AAAAA” is described. For the sub content S1, the content ID “BBBBB” is described. For the sub content S2, the content ID “CCCCC” is described. Based on the content IDs described in the index file IF, the main content M, the sub content S1 and the sub content S2 are acquired, respectively. A detailed method of acquisition will be described later. Location information in the structure of the composite content such as the hierarchical structure SR is not limited to “/”, “/pie/” and the like. Any type of location information may be used as long as the location information indicates the location in the structure of the composite content. When the index file IF is acquired, the content ID of a content located in each hierarchical structure is acquired. Then, the user node can acquire the content based on the acquired content ID.

In addition, another example of the hierarchical structure of the composite content of the first embodiment is a hierarchical structure constituted by a plurality of folders. For example, a hierarchical structure SR2 illustrated in FIG. 2C has a structure in which a first folder FD1 is at the highest location, and a second folder FD2 and a third folder FD3 are located under the first folder FD1. A fourth folder FD4, a sixth folder FD6 and a seventh folder FD7 are located under the third folder FD3. Further, a fifth folder FD5 is located under the fourth folder FD4.

It is assumed that in the hierarchical structure SR2, the contents constituting the composite content are a first content C1, a second content C2, a third content C3 and a fourth content C4. In this case, the first content C1 is stored in the second folder FD2. The second content C2 is stored in the fourth folder FD4. The third content C3 is stored in the fifth folder FD5. The fourth content C4 is stored in the sixth folder FD6. The index file for the composite content having such a hierarchical structure SR2 is an index file IF2 illustrated in FIG. 2C. In the index file IF2 shown in FIG. 2C, the description of the content ID assigned to each content C is omitted.

More specifically, in FIG. 2C, the index file IF2 includes location information indicating a location where a content constituting the Web page is stored. For example, “/first folder/second folder/first content” indicates that the first content is located in the second folder under the first folder. In addition, “/first folder/third folder/fourth folder/second content” indicates the following: the third folder is located under the first folder, the fourth folder is located under the third folder, and the second content is located in the fourth folder.

(C) Concrete Configuration and Operation of Entry server and the Like

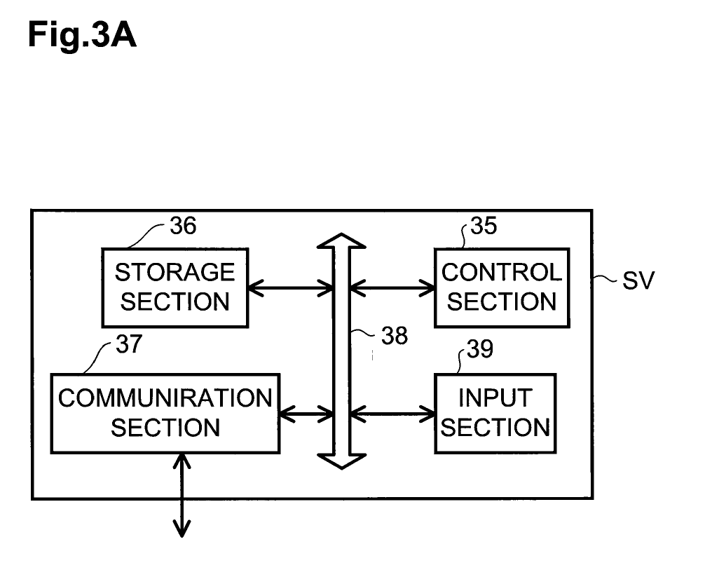

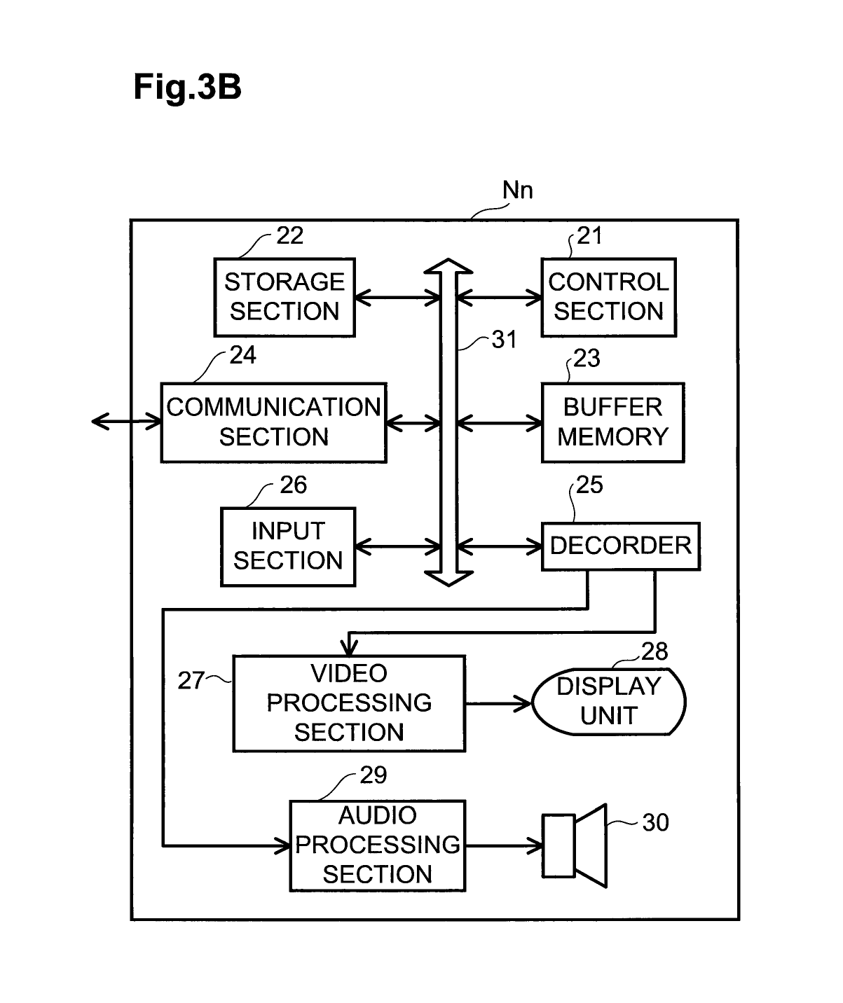

Next, the concrete configuration and operation of the entry server SV and the like included in the delivery system S of the first embodiment will be described with reference to FIGS. 3A and 3B to FIGS. 5A to 5D.

### (a) Concrete Configuration and Operation of Entry Server

First, the concrete configuration and operation of the entry server SV of the first embodiment will be described with reference to FIG. 3A. As shown in FIG. 3A, the entry server SV of the embodiment includes a control section 35, a storage section 36, a communication section 37 and an input section 39. These components are connected so as to enable mutual data transmission and reception through a bus 38.

The control section 35 includes a CPU (Central Processing Unit), a RAM (Random Access Memory), a ROM (Read Only Memory) and the like. The CPU has a calculation function. The RAM stores various types of data. The ROM stores various types of data and programs. The various types of data and programs include an operating system and various types of applications. The storage section 36 includes a hard disk and the like for storing various types of data, programs and the like. The communication section 37 controls communication of various messages with nodes through the network 8. In addition, the input section 39 receives an instruction from the user and gives the control section 35 an instruction signal according to the instruction. The input section 39 is achieved with, for example, a keyboard, a mouth and the like.

In the above configuration, the CPU in the control section 35 executes the program stored in the storage section 36, the ROM or the like. When the program is executed, the control section 35 collectively controls the entire entry server SV. In addition, the control section 35 performs each operation as the entry server SV in the content delivery operation of the first embodiment described later.

### (b) Concrete Configuration and Operation of Node

Next, the concrete configuration and operation of a node of the first embodiment will be described with reference to FIG. 3B. As shown in FIG. 3B, the node of the embodiment includes a control section 21, a storage section 22, a buffer memory 23, a communication section 24, a decoder 25, an input section 26, a video processing section 27, a display unit 28, an audio processing section 29 and a speaker 30. The control section 21, the storage section 22, the buffer memory 23, the communication section 24, the decoder 25, and the input section 26 are connected so as to enable mutual data transmission and reception through a bus 31.

In this configuration, the control section 21 includes a CPU, a RAM, a ROM and the like. The CPU has a calculation function. The RAM stores various types of data. The ROM stores various types of data and programs. The storage section 22 includes a hard disk and the like for storing various types of data and programs. The buffer memory 23 temporarily accumulates contents received through the communication section 24. The decoder 25 decodes encoded video data, audio data and the like contained in a content. The video processing section 27 performs predetermined drawing processing on the decoded video data and the like, and outputs the data as a video signal. The display unit 28 constituted by a liquid crystal display or the like displays video corresponding to the video signal output from the video processing section 27. The audio processing section 29 performs D (Digital)/A (Analogue) conversion of the decoded audio data into an analog audio signal, and then amplifies the signal for output to the speaker 30. The speaker 30 outputs the audio signal output from the audio processing section 29 as an acoustic wave. The communication section 24 performs communication control with respect to data transmission and reception through the network 8 to and from another node, the entry server SV and the like. The input section 26 receives an instruction from the user and outputs to the control section 21 an instruction signal according to the instruction. The input section 26 is achieved with, for example, a keyboard, a mouth, an operation panel and the like.

Practically, the node may be achieved as a so-called personal computer, STB (Set Top Box), television receiver or the like. The storage section 22 stores a node processing program of the embodiment, a file serving as a content, a routing table using the DHT and the like. In the above configuration, the CPU in the control section 21 reads out and executes the node processing program stored in the storage section 22, the ROM or the like. When the program is executed, the control section 21 collectively controls the entire node. More specifically, after the node participated in the delivery system S, the control section 21 executes the node processing program. Then, the node functions as at least one of the user node, the root node, the holding node and the like described above.

### (D) Content Delivery Operation

Next, the content delivery operation in the delivery system S of the first embodiment will be described specifically with reference to FIGS. 2A to 2C to FIGS. 5A and 5B.

First, the operation in an instruction server (not shown) included in the delivery system S of the first embodiment will be described with reference to FIGS. 2A to 2C, FIG. 4A and FIGS. 5A and 5B.

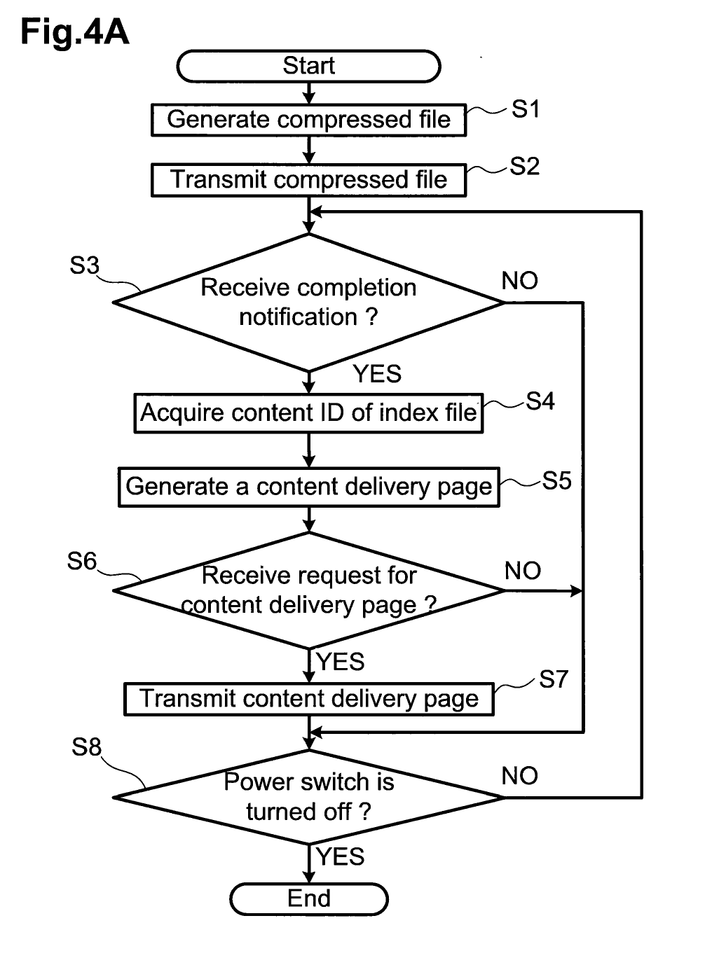

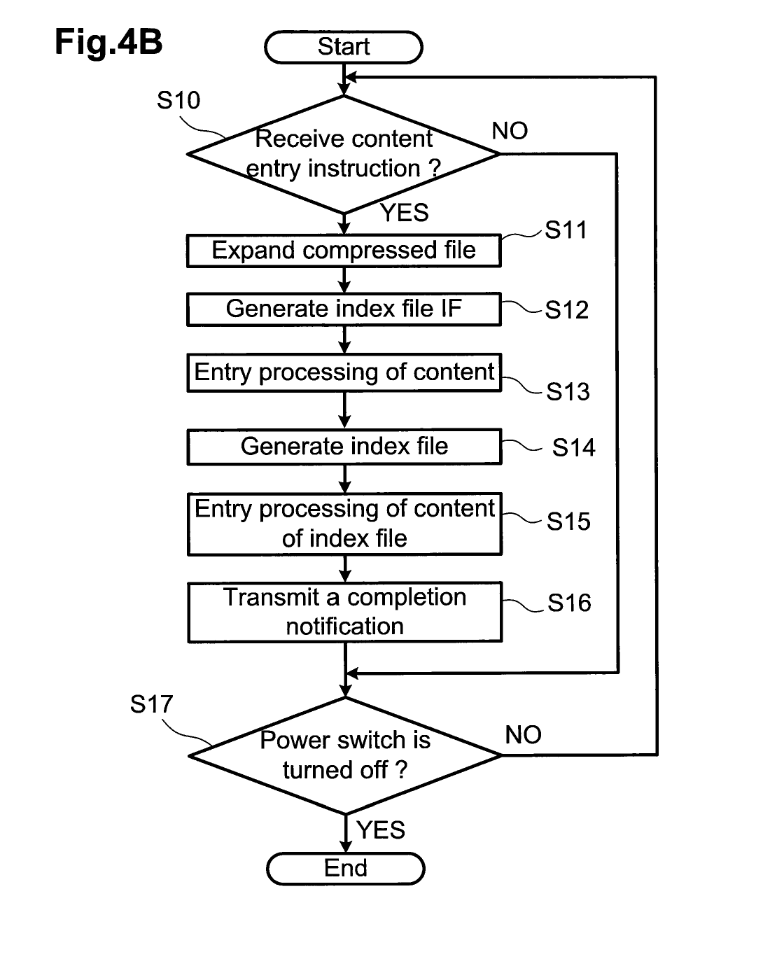

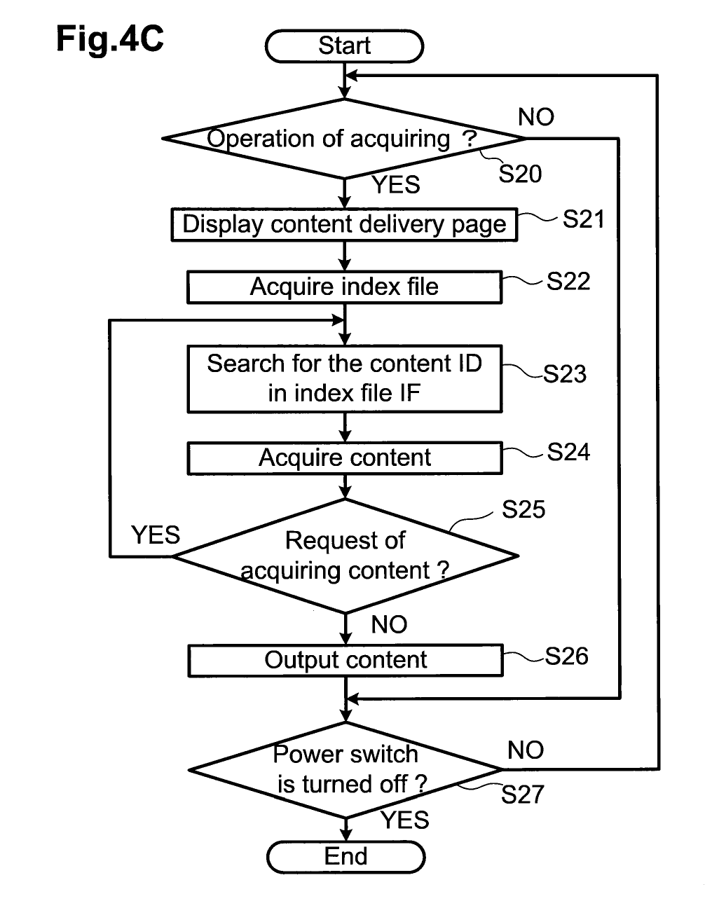

As shown in FIG. 4A, in the instruction server of the first embodiment, a power switch (not shown) is turned on. When the instruction server receives an entry instruction of the composite content from an entry instructor, a control section of the instruction server starts the operation of the flowchart in FIG. 4A. The instruction server first gathers a plurality of contents constituting the composite content into the compressed file P as the structure is maintained (step S1). The compressed file P is illustrated in FIG. 2B. The compressed file P is one file that gathers the main content M and the sub contents S1 and S2 constituting the composite content illustrated in FIG. 2A. Here, the compressed file P of FIG. 2B is an image illustrating that the main content M and the sub contents S1 and S2 are gathered into one compressed file. “Gathering into one compressed file P” does not mean that the data amount of each content constituting the composite content is reduced, but “Gathering into one compressed file P” means that the main content M and the sub contents S1 and S2 can be handled as one file and the structure of a composite content is maintained. In the compressed file P after compression, information indicating an original structure is described as, for example, header information thereof.

Turning back to FIG. 4A, the instruction server next transmits the compressed file P gathered in the operation of step S1 to the entry server SV according to an entry instruction (step S2). The entry instruction is an instruction to enter a content to the delivery system S. Then, the instruction server monitors whether or not a completion notification is transmitted from the entry server SV (step S3). The completion notification indicates that the entry of the composite content corresponding to the compressed file P into the delivery system S is completed. The reception of completion notification is monitored in step S3 includes the content ID of the index file IF.

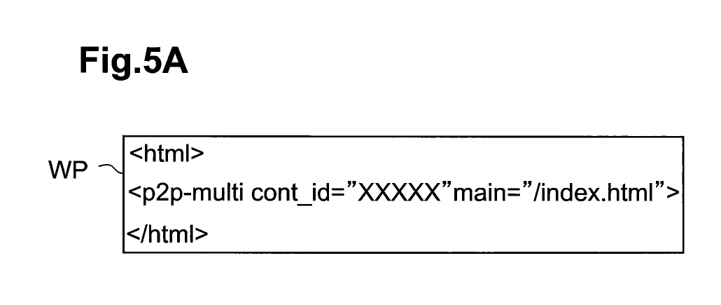

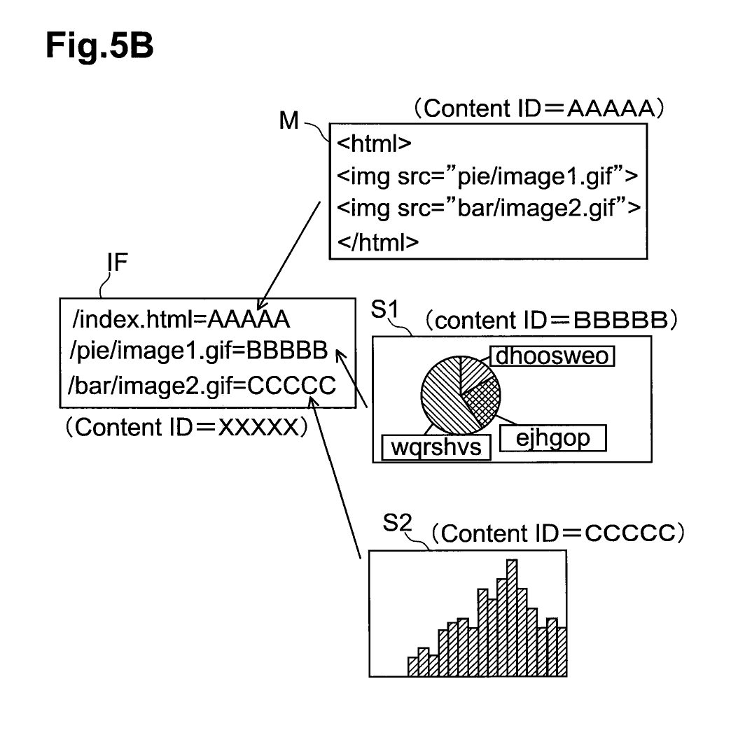

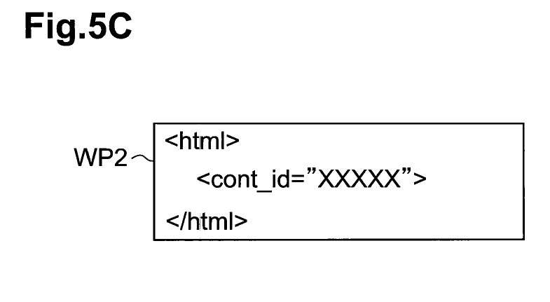

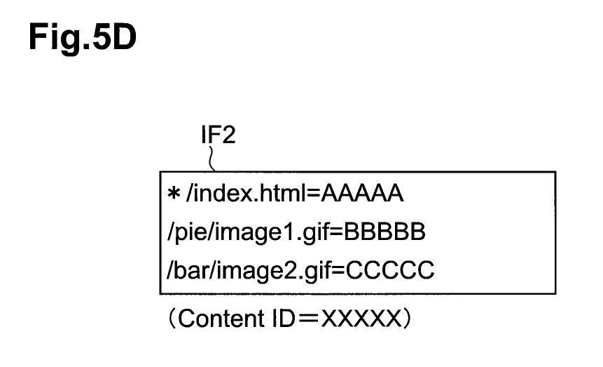

If no completion notification is received in step S3 (step S3; NO), the instruction server proceeds to the operation of step S8. On the other hand, if the completion notification is received in step S3 (step S3; YES), the instruction server acquires the content ID of the index file IF from the received completion notification (step S4). Then, the instruction server uses the content ID acquired in the operation of step S4 to generate a content delivery page and stores the page (step S5). The content delivery page is a Web page used for delivery of contents constituting the composite content. The content delivery page is a Web page to be viewed by the node of the user who desires to deliver the composite content as described later. FIG. 5A shows an example of a page data WP corresponding to the content delivery page. The instruction server includes the content ID of the index file IF and the file path in the page data WP. The file path is information indicating the location of the main content M in the composite content. That is to say, the file path is an example of the location information of the embodiment. FIG. 5A illustrates the case where the content ID of the index file IF is “XXXXX”, and the file path indicating the location of the main content M is “/index.html”. The page data WP illustrated in FIG. 5A also includes “p2p-multi”. The “p2p-multi” is information indicating that what is to be acquired is a composite content.

Next, the instruction server determines whether or not the request for the content delivery page stored in the operation of step S5 is transmitted from the node (step S6). If no request is transmitted in step S6 (step S6; NO), the instruction server proceeds to the operation of step S8 described later. If the request is transmitted in step S6 (step S6; YES), the instruction server transmits the requested content delivery page to the node that is a request source (step S7).

Then, the instruction server determines whether or not a power switch is turned off (step S8). If the power switch is not turned off in step S8 (step S8; NO), the instruction server proceeds to the operation of step S3. If the power switch is turned off in step S8 (step S8; YES), the instruction server completes the content delivery operation of the first embodiment.

Next, the operation in the entry server SV of the first embodiment will be described with reference to FIGS. 2A to 2C, FIG. 4B and FIGS. 5A and 5B.

As shown in FIG. 4B, when the power switch (not shown) of the entry server SV is turned on, the control section 35 of the entry server SV starts the processing of the flowchart shown in FIG. 4B. First, the control section 35 monitors whether or not the content entry instruction and the compressed file P are received from the instruction server (step S10, see step S2 of FIG. 4A). If no content entry instruction and the like is received in step S10 (step S10; NO), the control section 35 proceeds to the operation of step S17. On the other hand, if the content entry instruction and the like are received in step S10 (step S10; YES), the control section 35 expands the compressed file P received according to the content entry instruction. Then, the control section 35 acquires the main content M and the sub contents S1 and S2 (step S11). Specifically, this operation of step S11 causes the control section 35 to acquire the main content M and the sub contents S1 and S2 contained in the compressed file P. Then, the control section 35 acquires information indicating the hierarchical structure SR. The information indicating the hierarchical structure SR is described in the header information of the compressed file P. Next, the control section 35 generates the index file IF (step S12). In the generated index file IF, the location information in the hierarchical structure SR of the expanded compressed file P and the name information are described. When the compressed file P with the content illustrated in FIG. 2B is expanded, the control section 35 generates a file. The generated file is comprised by following information. The information is that the description of the content ID is removed from the index file IF illustrated in FIG. 2B.

Next, the control section 35 performs entry processing into the delivery system S of each content contained in the compressed file P. Then, the control section 35 assigns content IDs to respective contents (step S13). For this content ID assignment method, methods similar to those described in US Patent Application Publication No. 2007/283043A1 which is incorporated by reference, may be used. The operation of step S13 allows each node to acquire each content contained in the compressed file P. Next, the control section 35 adds the assigned content ID into the index file IF so as to be associated with the content (step S14). More specifically, the assigned content ID is associated with the content identified with the content ID. Then, the associated content ID is added into the index file IF. One of examples of the index file IF to which the content ID is added is illustrated in FIG. 2B and FIG. 5B. FIG. 5B illustrates a case where the content ID “AAAAA” is assigned to the main content M. FIG. 5B also illustrates a case where the content ID “BBBBB” is assigned to the sub content S1. FIG. 5B also illustrates a case where the content ID “CCCCC” is assigned to the sub content S2. In this case, the control section 35 adds the content ID “AAAAA” to the location of the main content M of the index file IF (see the solid arrow in FIG. 5B). Similarly, the control section 35 adds the content ID “BBBBB” to the location of the sub content S1. The control section 35 adds the content ID “CCCCC” to the location of the sub content S2 (see the solid arrows in FIG. 5B).

Next, the control section 35 performs entry processing into the delivery system S of the added index file IF similarly to step S13. Then, the control section 35 assigns the content ID to the index file IF itself (step S15). The operation of step S15 allows each node to acquire the index file IF as a content. Then, the control section 35 transmits a completion notification to the instruction server (step S16). The completion notification indicates that the entry of each content contained in the compressed file P and the index file IF into the delivery system S is completed. Next, the control section 35 determines whether or not the power switch of the entry server SV is turned off (step S17). If the power switch is not turned off in step S17 (step S17; NO), the control section 35 proceeds to the operation of step 510. If the power switch is turned off in step S17 (step S17; YES), the control section 35 completes the content delivery operation of the first embodiment.

The operation in the node of the first embodiment will be described with reference to FIGS. 2A to 2C, FIG. 4C and FIGS. 5A and 5B. The operation shown in FIG. 4C is the operation of the node serving as a user node.

As shown in FIG. 4C, when the power switch (not shown) of the node is turned on, the control section 21 of the node of the first embodiment starts the processing of the flowchart shown in FIG. 4C. First, the control section 21 monitors whether or not the operation by the user who requests to acquire a composite content is performed in the input section 26 in step S20 (step S20). If the operation by the user is not performed in the monitoring in step S20 (step S20; NO), the control section 21 proceeds to the operation of step S27. On the other hand, if the operation by the user is performed in step S20 (step S20; YES), the control section 21 acquires the page data WP corresponding to the operation. Then, the control section 21 displays the content delivery page on the display unit 28 (step S21). The content delivery page is generated by the instruction server via the operation of step S5 in FIG. 3A. FIG. 5A illustrates the corresponding page data WP.

Next, the control section 21 acquires the content ID of the index file IF contained in the displayed content delivery page. Then, the control section 21 transmits a query based thereon and acquires the index file IF (step S22). That is to say, the control section 21 acquires the index file IF based on the content ID of the index file IF contained in the displayed content delivery page. As an example of the operation of step S22, the control section 21 transmits a query including the content ID of the acquired index file IF. Then, the control section 21 acquires the index information responding to the transmitted query from the root node of the index file IF. Thus, the control section 21 accesses the holding node of the index file IF based on the acquired index information. Then, the control section 21 acquires the index file IF. The control section 21 searches for the content ID in the index file IF (step S23). In step S23, the content ID corresponding to the location information and name information matching the file path described in the content delivery page is retrieved. In the illustration of FIGS. 2A to 2C and FIG. 5A, the file path described in the content delivery page is “/index.html”. The control section 21 searches for the content ID corresponding to the location information and name information matching “/index.html” in the index file IF. Thus, the control section 21 retrieves the content ID “AAAAA” as the content ID corresponding to the location information and name information “/index.html”. Next, the control section 21 transmits a query based on the retrieved content ID “AAAAA”. Then, the control section 21 acquires the corresponding main content M (step S24). In step S24, the control section 21 uses the content ID “AAAAA” to access the holding node for the main content M, and acquires the main content M.

Then, the control section 21 determines whether or not content is required to acquired (step S25). The required content is a content corresponding to the name and location information of sub content S1 and the like described in the acquired main content M. If the other sub content S1 and the like are required to be acquired in step S25 (step S25; YES), the control section 21 performs step S23. At that time, in step S23, the control section 21 refers to the index file IF, and searches for the content ID corresponding to the location information of the sub content S1 and the like that is requested to be acquired. For example, for the sub content S1 of FIG. 2A, the main content M includes the following two pieces of information: the name of the sub content S1 “image1.gif” and location information “pie!” indicating the location in the hierarchical structure SR. Then, the control section 21 searches for the content ID “BBBBB” corresponding to the location information in the index file IF. The operations from steps S23 to S25 are repeated in this manner, thereby the control section 21 acquires the main content M and the sub contents S1 and S2. The control section 21 repeats the operation of step S23 for all of the sub contents S1 and S2. On the other hand, if the other sub contents are not required to be acquired in the determination of step S25 (step S25; NO), the control section 21 displays the Web page on the display unit 28 (step S26). The Web page displayed in step S26 may be displayed using the main content M and the sub contents S1 and S2 acquired by the operations from steps S23 to S25.

Then, the control section 21 determines whether or not the power switch of the node is turned off (step S27). If the power switch is not turned off in step S27 (step S27; NO), the control section 21 proceeds to the operation of step S20. If the power switch is turned off in step S27 (step S27; YES), the control section 21 completes the content delivery operation of the first embodiment.

As described above, according to the content delivery operation of the first embodiment, the control section 35 of the entry server SV generates an index file. Then, the control section 35 enters the index file into the delivery system S. Therefore, the node that acquires the index file IF may recognize the location of each content in the structure and the content ID thereof. Accordingly, the node can acquire each content through the delivery system S with simplified processing as an original predetermined structure is maintained.

The control section 35 of the entry server SV also acquires the compressed file P. Then, the control section 35 assigns content IDs to respective contents contained in the compressed file P. In addition, the control section 35 refers to the main content M contained in the compressed file P and generates the index file IF containing the location information. Therefore, even if a composite content to be entered is constituted by a large number of contents, the index file IF may be generated as a predetermined structure is maintained.

Further, the control section 21 of the node acquires the index file IF from the delivery system S based on the content ID for identifying the index file IF. Then, the control section 21 acquires a required content based on the content ID contained in the index file IF. Thus, each content may be acquired through the delivery system S as the original predetermined structure is properly recognized.

In addition, the control section 21 acquires the index file IF from the delivery system S based on the content ID contained in the content delivery page. Therefore, the content ID for identifying the index file IF may be acquired with simplified processing and the control section 21 can acquire content corresponding to content ID contained in index file IF.

Moreover, when the location information indicating the location of the main content M is contained in the content delivery page, the control section 21 determines the content ID associated with the location information. Therefore, the node may recognize the main content M easily.

The file path “/index.html” indicating the location of the main content M of the first embodiment may be described in the record of the main content M in the catalog information. For example, the file path may be described in a special keyword portion of the catalog information. The catalog information may be delivered to each node by, for example, a multicast method in the delivery system S. The control section 21 of the user node recognizes the location of the main content M in the hierarchical structure SR based on the file path described in the delivered catalog information. Thus, the control section 21 can acquire the main content M.

### (II) Second Embodiment

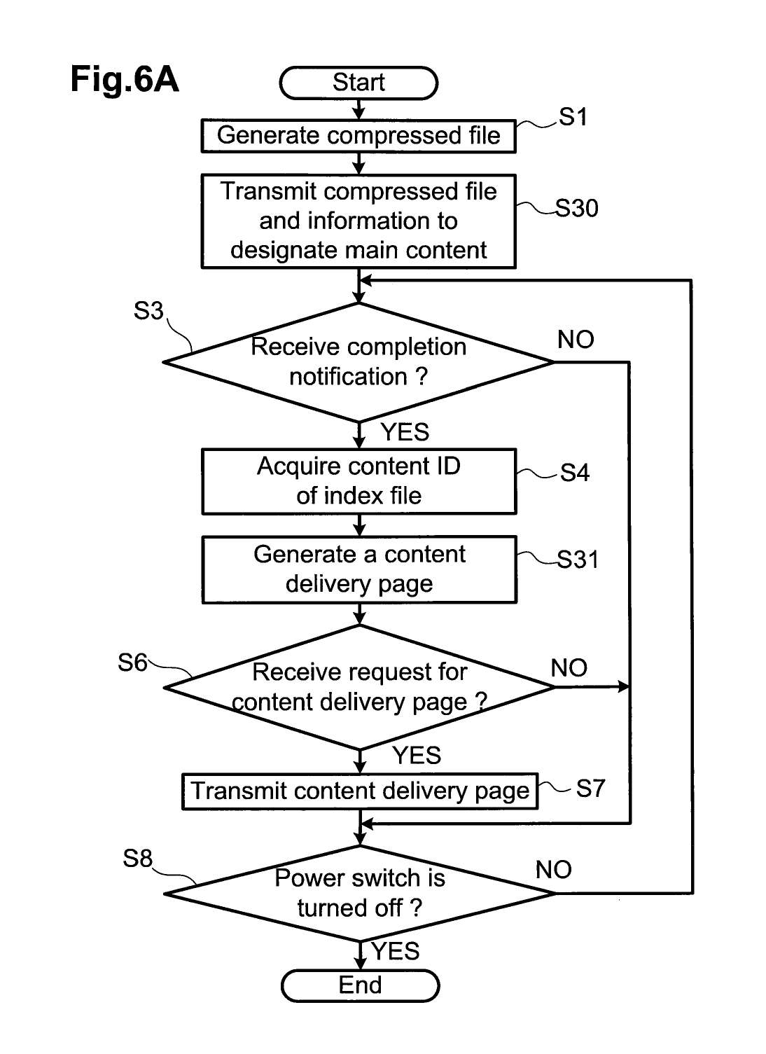

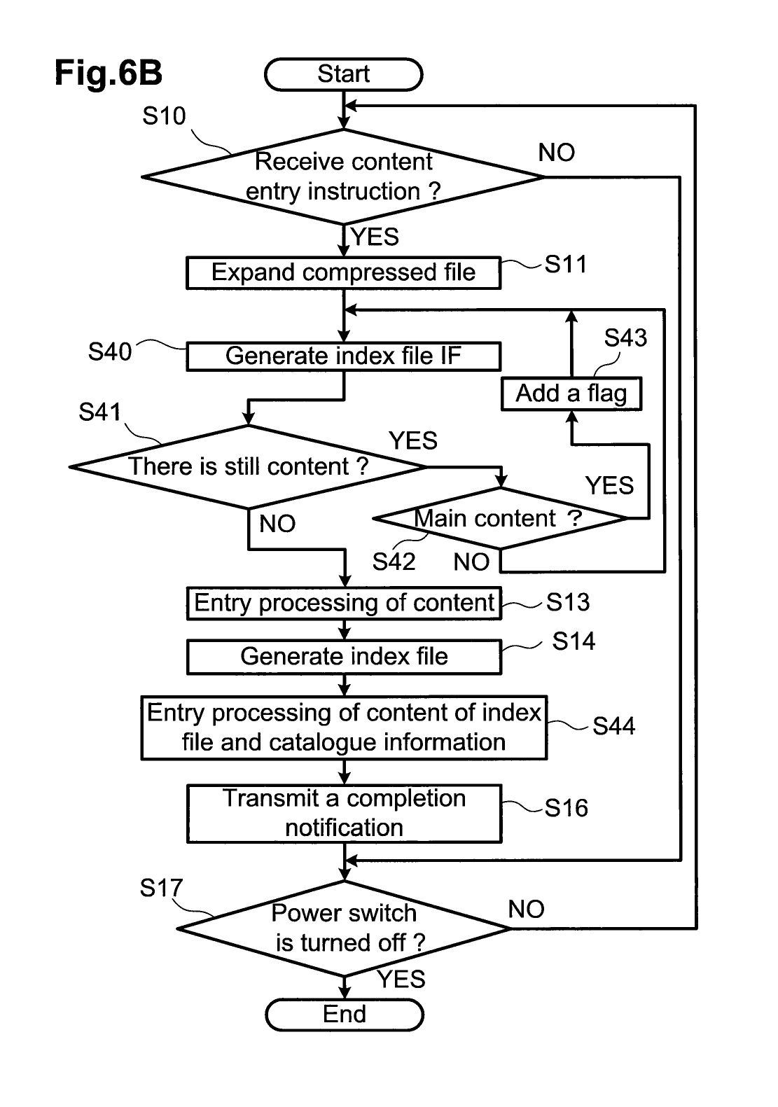

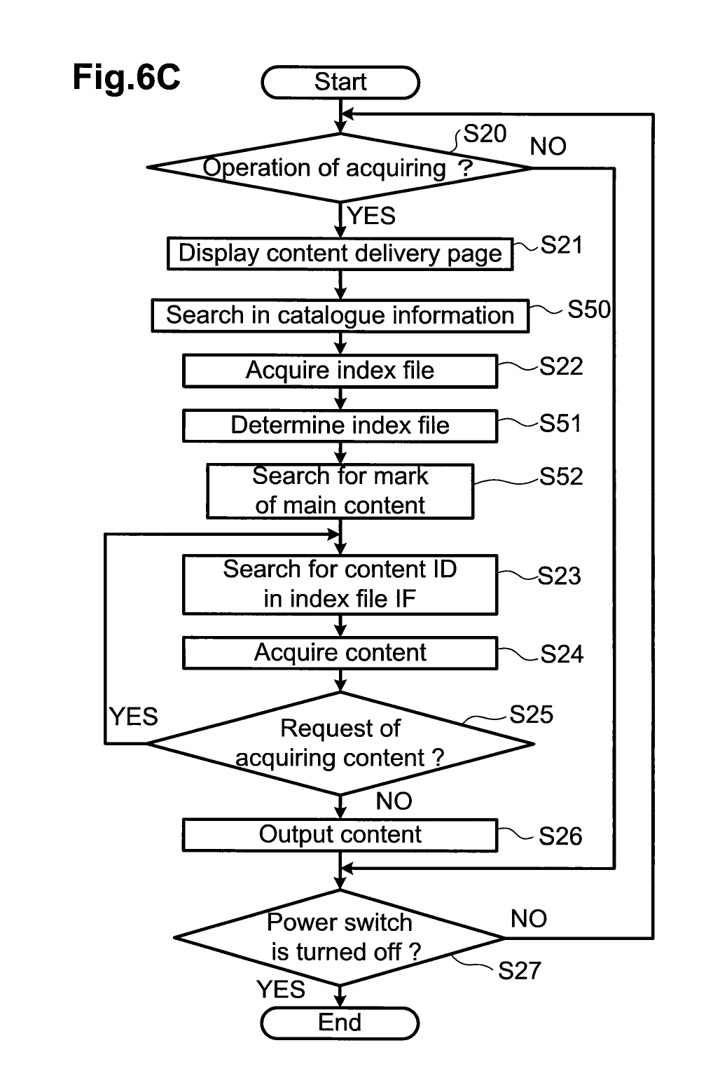

Next, a content delivery operation of a second embodiment will be described with reference to FIGS. 5C and 5D and FIGS. 6A to 6C.

In the first embodiment, the composite content information indicative of being a composite content, the content ID of the index file IF, and the file path of the main content M are described in the content delivery page. In the second embodiment, description of the composite content information and the file path of the main content M may be omitted in the content delivery page. Instead, in the second embodiment, a flag indicative of being the main content M is described in the index file. In addition, an index file symbol indicative of being an index file is described in the keyword of the catalog information.

An electrical configuration of the delivery system of the second embodiment is basically same to the delivery system S of the first embodiment. Therefore, in the following description, the member numbers of the delivery system S of the first embodiment are used to describe the operation. Further, in the flowcharts shown in FIGS. 6A to 6C, operations that are similar to the content delivery operation of the first embodiment in FIGS. 4A to 4C will be assigned same step numbers of the first embodiment. In addition, detailed description is omitted for the operations that are similar to the content delivery operation of the first embodiment of FIGS. 4A to 4C.

Next, the content delivery operation in the delivery system S of the second embodiment will be described specifically. First, the operation in the instruction server (not shown) included in the delivery system S of the second embodiment will be described with reference to FIG. 5C and FIG. 6A. As shown in FIG. 6A, when the power switch (not shown) is turned on, the instruction server of the second embodiment starts the processing of the flowchart shown in FIG. 6A. First, the control section 35 performs similar operation to that of step S1 shown in FIG. 4A. Here, it is assumed that a structure of the composite content delivered by the content delivery operation of the second embodiment is similar to that of the hierarchical structure SR of the first embodiment (see FIG. 2A or FIG. 2B).

Next, the instruction server transmits the compressed file P gathered in the operation of step S1 to the delivery system S (step S30). In step S30, the compressed file P is transmitted to the entry server SV according to the content entry instruction. Further, in step S30, the instruction server adds information indicating that the compressed file P is a composite content to the content entry instruction, and transmits the content entry instruction. Further, the instruction server adds information to designate the main content M to the content entry instruction, and transmits the content entry instruction.

Then, the instruction server performs similar operations to those of steps S3 and S4 shown in FIG. 4A, respectively. Next, the instruction server generates a content delivery page of the second embodiment using the content ID of the index file IF acquired in the operation of step S4 (step S31). The page data WP of the content delivery page of the second embodiment includes only the content ID of the index file IF as illustrated in FIG. 5C. Then, the instruction server performs similar operations to those of steps S6 to S8 shown in FIG. 4A, and completes the content delivery operation of the second embodiment.

Next, the operation in the entry server SV of the second embodiment will be described with reference to FIG. 5D and FIG. 6B. As shown in FIG. 6B, when the power switch (not shown) of the entry server SV is turned on, the control section 35 of the entry server SV of the second embodiment starts the processing of the flowchart shown in FIG. 6B. First, the control section 35 performs similar operations to those of steps S10 and S11 shown in FIG. 4B, respectively. The following two pieces of information are added to the content entry instruction received in the operation of step S10 of the second embodiment: information indicating that the compressed file P to be transmitted is a composite content, and information to designate the main content M.

Next, the control section 35 generates the index file IF of the second embodiment (step S40). Location information and name information are described in the index file IF of the second embodiment. The location information is location information in the hierarchical structure SR of the expanded compressed file P. In step S40, the control section 35 first determines one of contents contained in the compressed file P. Then, the control section 35 describes the location information and name information of the determined content in the index file IF. Next, the control section 35 determines whether or not there is still in the compressed file P a content which location information and name information are not described in the index file IF (step S41). If there is no content which location information and name information are not described in the index file IF in step S41 (step S41; NO), the control section 35 performs the operation of step S13. On the other hand, if there is the content which location information and name information are not described in the index file IF in step S41 (step S41; YES), the control section 35 determines whether or not the content which location information and name information are not described is the main content M (step S42). In step S42, the control section 35 determines whether or not the content is the main content. In step S42, the control section 35 determines it based on information to designate the main content M contained in the content entry instruction received in step S10. If the control section 35 determines that the content is not the main content M in step S42 (step S42; NO), the control section 35 performs step S40. On the other hand, if the control section 35 determines that the content is the main content M in step S42 (step S42; YES), the control section 35 adds a flag indicating that the content is the main content to the index file IF (step S43). This flag corresponds to an example of “main content indication information”. The flag is, for example, a mark of “*”. Then, the control section 35 performs step S40. When the operations from steps S40 to S43 are performed on the composite content illustrated in FIG. 2A and FIG. 2B, the control section 35 generates the index file IF2 with the content illustrated in FIG. 5D. The mark of * indicating that the content is the main content M is described at a location corresponding to the main content M in the generated index file IF2.

Then, the control section 35 performs similar operations to those of steps S13 and S14 in FIG. 4B, respectively. Next, the control section 35 performs entry processing into the delivery system S of the generated index file IF2. Then, the control section 35 assigns a content ID to the index file IF2 (step S44). Further, the control section 35 performs the entry processing to the delivery system S of the catalog information corresponding to the index file IF2 to which the content ID is assigned (step S44). At that time, an index file symbol indicative of being the index file IF2 is added to the entered keyword of the catalog information. The operation of step S44 allows each node to acquire the index file IF2 and the corresponding catalog information.

Then, the control section 35 performs similar operations to those of steps S16 and S17 shown in FIG. 4B, respectively, and completes the content delivery operation of the second embodiment.

The operation in the node of the second embodiment will be described with reference to FIG. 6C. The operation illustrated in FIG. 6C is the operation of the node as a user node as in the first embodiment.

As shown in FIG. 6C, when the power switch (not shown) of the node is turned on, the control section 21 of the node starts the processing of the flowchart shown in FIG. 6C. First, the control section 21 performs similar operations to those of steps S20 and S21 shown in FIG. 4C, respectively. The content delivery page displayed in step S21 does not contain information indicative of being a composite content and to designate the main content M.

Next, the control section 21 acquires the content ID of the index file IF2 contained in the displayed content delivery page. Then, the control section 21 searches in the catalog information acquired in step S44 based on the acquired content ID (step S50). Then, the control section 21 uses a search result of step S50 to transmit a query, and acquires the index file IF (step S22). Next, the control section 21 verifies a catalog keyword corresponding to the acquired index file IF2 in the catalog information. Then, the control section 21 determines that the content acquired in the operation of step S22 is the index file IF2 (step S51). Step S51 becomes executable by the addition of the index file symbol of the index file IF2 to the catalog information of the second embodiment. Next, the control section 21 searches for the mark of * in the acquired index file IF2 (step S52). The mark of * indicates t the main content M.

Then, the control section 21 performs similar operations to those of steps S23 to S27 shown in FIG. 4C, respectively. Then, the control section 21 completes the content delivery operation of the second embodiment. In the first operation of step S23 at that time, based on the mark of * retrieved in step S52, first the content ID of the main content M is retrieved. Thereafter, the control section 21 repeats operations from steps S23 to S25 to acquire the main content M and then acquire the sub contents S1 and S2.

As described above, in the second embodiment, the original predetermined structure is maintained, similarly to the content delivery operation of the first embodiment. Then, with the delivery system S, a node acquires each content with simplified processing. In addition, even if a composite content to be entered is constituted by a large number of contents, the index file IF2 may be generated as a predetermined structure is maintained.

In addition, according to the content delivery operation of the second embodiment, the mark of * indicative of being the main content M is included in the index file IF2. Thus, each node may acquire each content while properly adapting to the predetermined structure.

Further, the catalog information in which the index file symbol identifying the index file IF2 is included is entered into the delivery system S. Therefore, at the node that acquires the catalog information, the index file IF2 can be recognized by discrimination against other contents.

The program corresponding to the operation shown in FIG. 4B or FIG. 6B may be downloaded from, for example, a predetermined server connected to the network 8 to the entry server SV. In addition, the program may be recorded in, for example, a recording medium. In this case, the program may be read and executed by the control section 35 of the entry server SV through a drive of the recording medium.

Similarly, the program corresponding to the operation shown in FIG. 4C or FIG. 6C may be downloaded from, for example, a predetermined server connected to the network 8 to each node. In addition, the program may be recorded in, for example, a recording medium. In this case, the program may be read and executed by the control section 21 of the node through a drive of the recording medium.

In the structure of the composite content, the location information indicating the location of the main content M may be included in “main content indication information”. In embodiments, for example, the location information of the main content M is “/” as illustrated in FIG. 2B. In this case, the content ID of the main content M is determined based on the location information indicating the location of the main content M and the index file IF. Then, based on the determined content ID, a query for requesting the main content M may be transmitted from the user node to the overlay network 9.

The method described in this application can be used in the field of delivery systems for delivering contents. Particularly remarkable effects may be obtained in particular by application to cases of composite contents being delivered in P2P-type network systems.

What is claimed is:

1. An information communication system comprising an information processing apparatus and a plurality of node devices in which contents delivered within the information communication system are stored in a distributed manner by an overlay network constituted by the plurality of node devices, the information processing apparatus comprising:
an acquisition unit configured to acquire a plurality of contents associated by a predetermined structure;
a first assignment unit configured to assign identification information for identifying the contents in the overlay network to the plurality of contents acquired by the acquisition unit;
a generation unit configured to generate first information comprising location information indicating locations of the plurality of contents in the predetermined structure and the identification information for identifying the plurality of contents associated by the predetermined structure, and the location information and the identification information are corresponding to each other;
a second assignment unit configured to assign identification information for identifying the first information in the overlay network to the first information; and
an entry unit configured to enter into the overlay network the plurality of contents acquired by the acquisition unit and the first information.

2. The information communication system according to claim 1, wherein the node devices comprises:
a second acquisition unit that, based on the identification information of the first information entered by the entry unit, acquires from the overlay network the first information identified by the identification information; and
a transmission unit that, based on the acquired first information, transmits to the overlay network a request message to request the contents identified by the identification information contained in the first information.

3. The information communication system according to claim 1, wherein
the acquisition unit acquires a main content that is used to acquire at least one of the plurality of contents and includes the identification information of the at least one of the plurality of the contents associated with the main content,
the first assignment unit assigns the identification information to the plurality of contents and the main content acquired by the acquisition unit, and
the generation unit generates the first information containing the identification information of the main content.

4. The information communication system according to claim 3, wherein
the generation unit generates the first information containing main content indication information indicating the main content from among the plurality of contents associated by a predetermined structure.

5. The information communication system according to claim 1, wherein
the information processing apparatus further comprises a catalog information generation unit configured to generate catalog information used in a search for the contents and the first information within the overlay network, and the catalogue information contains at least either the identification information for identifying the contents or the identification information for identifying the first information; and
the entry unit enters into the overlay network the catalog information generated by the catalog information generation unit.

6. The information communication system according to claim 2, wherein
the node devices comprises:
a page information acquisition unit configured to acquire page information acquirable through the network, and contains the identification information for identifying the first information, and
the second acquisition unit acquires from the overlay network, the first information identified by the identification information contained in the page information acquired by the page information acquisition unit.

7. The information communication system according to claim 5, wherein
the node devices comprises:
a second acquisition unit that, based on the identification information for identifying the first information, configured to acquires the first information from the overlay network; and
a transmission unit that, based on the first information acquired by the second acquisition unit, transmits to the overlay network a request message to request the contents identified by the identification information contained in the first information, wherein the catalog information or the page information contains main content indication information indicating a main content used to acquire the contents, and
the transmission unit transmits to the overlay network the request message to request the main content indicated by the main content indication information, based on the main content indication information and the first information acquired by the second acquisition unit.

8. The information communication system according to claim 4, wherein the node devices comprises:
a second acquisition unit that, based on the identification information for identifying the first information, is configured to acquire the first information from the overlay network; and
a transmission unit that, based on the first information acquired by the second acquisition unit, transmits to the overlay network a request message to request the contents identified by identification information contained in the first information, wherein the transmission unit transmits to the overlay network the request message to request the main content, based on the main content indication information contained in the first information.

9. The information communication system according to claim 1, wherein the information processing apparatus is any of the plurality of node devices constituting the overlay network.

10. An information communication system comprising an information processing apparatus and a plurality of node devices in which contents delivered within the information communication system are stored in a distributed manner by an overlay network constituted by the plurality of node devices, the information processing apparatus comprising:
an acquisition unit configured to acquire a plurality of contents associated by a predetermined structure;
a first assignment unit that configured to assign identification information for identifying the contents in the overlay network to the plurality of contents acquired by the acquisition unit;
a generation unit that configured to generate first information comprising location information indicating locations of the plurality of contents in the predetermined structure and the identification information for identifying the plurality of contents associated by the predetermined structure, and the location information and the identification information are corresponding to each other;
a second assignment unit that configured to assign identification information for identifying the first information in the overlay network to the first information; and
an entry unit that configured to enter into the overlay network the plurality of contents acquired by the acquisition unit and the first information.

11. A non-transitory computer readable storage medium storing a program that causes a computer included in an information processing apparatus of an information communication system comprising the information processing apparatus and a plurality of node devices in which contents delivered within the information communication system are stored in a distributed manner by an overlay network constituted by the plurality of node devices, to execute the steps of:
acquiring a plurality of contents associated by a predetermined structure;
assigning identification information for identifying the contents in the overlay network to the plurality of contents acquired;
generating first information comprising location information indicating locations of the plurality of contents in the predetermined structure and the identification information for identifying the plurality of contents associated by the predetermined structure, and the location information and the identification information are corresponding to each other;
assigning identification information for identifying the first information in the overlay network to the first information generated; and
entering into the overlay network the plurality of contents acquired and the first information generated.

12. An information communication method performed in an information communication system comprising an information processing apparatus and a plurality of node devices in which contents delivered within the information communication system are stored in a distributed manner by an overlay network constituted by the plurality of node devices, the information communication method comprising steps:
acquiring a plurality of contents associated by a predetermined structure;
assigning identification information for identifying the contents in the overlay network to the plurality of contents acquired in the acquisition step;
generating first information comprising location information indicating locations of the plurality of contents in the predetermined structure and the identification information for identifying the plurality of contents associated by the predetermined structure, and the location information and the identification information are corresponding to each other;
assigning identification information for identifying the first information in the overlay network to the first information generated in the generation step; and
entering into the overlay network the plurality of contents acquired in the acquisition step and the first information generated in the generation step.
